(19) United States
(12) Patent Application Publication
(10) Pub. No.: US 2013/0183012 A1
(43) Pub. Date: Jul. 18, 2013

(54) FAN-OUT KIT FOR A FURCATION SYSTEM

(71) Applicants: Alma Delia Cabanne Lopez, Reynosa (MX); Terry L. Cooke, Hickory, NC (US); Christopher S. Houser, Newton, NC (US); Diego Maldonalo Jimenez, Reynosa (MX); Matthew W. Smith, Lenoir, NC (US); James M. Wilson, Granite Falls, NC (US)

(72) Inventors: Alma Delia Cabanne Lopez, Reynosa (MX); Terry L. Cooke, Hickory, NC (US); Christopher S. Houser, Newton, NC (US); Diego Maldonalo Jimenez, Reynosa (MX); Matthew W. Smith, Lenoir, NC (US); James M. Wilson, Granite Falls, NC (US)

(21) Appl. No.: 13/420,110

(22) Filed: Mar. 14, 2012

Related U.S. Application Data
(60) Provisional application No. 61/586,474, filed on Jan. 13, 2012.

(51) Int. Cl. G02B 6/44; B23P 17/04; G02B 6/46

(52) U.S. Cl. 385/100; 29/428; 29/460; 29/426.2

(57) ABSTRACT

A furcation system of an optical fiber assembly includes a fan-out and a transition tube. The fan-out includes a surface and stations. The surface is flexible such that the surface is configured to be changed from flat to curved. The stations are coupled to one side of the surface and are configured to receive and hold sub-units of an optical fiber cable, while allowing the sub-units to project from the stations. The stations are spaced apart from one another such that the stations provide separation between the sub-units received by the stations. Bending of the surface moves the stations from a planar arrangement to a three-dimensional arrangement such that the sub-units may project from the stations of the fan-out in planar and three-dimensional arrays.

### CROSS-REFERENCE

This application claims the benefit of priority under 35 U.S.C. §119 of U.S. Provisional Application Ser. No. 61/586,474 filed on Jan. 13, 2012 the content of which is relied upon and incorporated herein by reference in its entirety.

### BACKGROUND

The present disclosure relates generally to data-transmission and communication cables, such as optical fiber cables. More specifically, the present disclosure relates to devices and methods for controlling the furcation (i.e., separation) of elements of a cable assembly, such as jacketed sub-units of an optical cable, which may include or consist of optical fibers.

Furcation systems (e.g., furcation bodies, furcation plugs) are typically used to facilitate parsing of sub-units of an optical fiber cable. For example, the outer jacket of the optical fiber may be removed or pulled back from the end of the optical fiber cable exposing the sub-units of the optical fiber cable. The sub-units typically include or consist of one or more optical fibers. The exposed sub-units are routed through a furcation system that physically separates the sub-units into furcated legs of the assembly. Connectors, such as local MTP connectors, may then be attached to distal ends of each of the legs.

When applying the furcation system to the sub-units of the optical fiber cable, the polarity of the individual optical fibers may be inadvertently switched, the fibers may be crossed with one another in an associated transition tube that receives the fibers, and the fibers may be inadvertently inverted. Each such problem may lead to increased optical fiber failure or connector failure and may require additional manufacturing correction. Accordingly, a need exists for a furcation system that includes components that facilitate accurate and efficient arrangement of the sub-units in a furcation system for manufacturing of an associated optical fiber cable assembly. A need exists for effectively managing 900-micron or otherwise-sized fibers in high-density hardware solutions and small-diameter, high-fiber-count cables within cable assembly manufacturing processes.

### SUMMARY

One embodiment relates to a furcation system of an optical fiber assembly, which includes a fan-out and a transition tube. The fan-out includes a surface and stations. The surface is flexible such that the surface is configured to be changed from flat to curved. The stations are coupled to one side of the surface and are configured to receive and hold sub-units of an optical fiber cable, while allowing the sub-units to project from the stations. The stations are spaced apart from one another such that the stations provide separation between the sub-units received by the stations. Bending of the surface moves the stations from a planar arrangement to a three-dimensional arrangement such that the sub-units may project from the stations of the fan-out in planar or three-dimensional arrays, depending upon the present configuration of the surface. The transition tube of the furcation system is configured to be attached to the fan-out and the optical fiber cable, and receives the sub-units from the optical fiber cable and provides the sub-units to the fan-out.

Another embodiment relates to a fan-out for a furcation system of an optical fiber assembly, which includes a surface and stations for receiving sub-units of an optical fiber cable. The surface is flexible and the surface, in a flat configuration, is elongate and has opposite lateral ends. The stations are coupled to one side of the surface, between the opposite lateral ends of the surface. Additionally, the stations are spaced apart from one another such that the stations provide separation between the sub-units received by the stations. The surface is flexible such that the opposite lateral ends of the surface are configured to be connected to one another, forming the fan-out in a cylindrical configuration with the stations on the interior of the cylinder.

Yet another embodiment relates to a method of using a furcation system. The method includes a step of inserting sub-units of an optical fiber cable into first ends of conduits positioned along a surface of a fan-out such that the sub-units extend through the conduits and project from second ends of the conduits. The surface is flexible. The method further includes a step of bending the surface to connect lateral ends of the surface to one another in order to form a cylinder with the conduits interior to the cylinder.

Additional features and advantages will be set forth in the Detailed Description which follows, and in part will be readily apparent to those skilled in the art from the description or recognized by practicing the embodiments as described in the written description and claims hereof, as well as the appended drawings. It is to be understood that both the foregoing general description and the following Detailed Description are merely exemplary, and are intended to provide an overview or framework to understand the nature and character of the claims.

### BRIEF DESCRIPTION OF THE FIGURES

The accompanying drawings are included to provide a further understanding, and are incorporated in and constitute a part of this specification. The drawings illustrate one or more embodiment(s), and together with the Detailed Description serve to explain principles and operation of the various embodiments. As such, the disclosure will become more fully understood from the following Detailed Description, taken in conjunction with the accompanying Figures, in which:

FIG. 1 is a perspective view of optical fiber routing in a housing with furcated legs of an optical fiber assembly attached to a blade server.

FIG. 2 is a perspective view of furcation systems separating sub-units of an optical fiber cable into furcated legs of an optical fiber assembly.

FIG. 3 is a perspective view of a fan-out in a first configuration according to an exemplary embodiment.

FIG. 4 is a front view of the fan-out of FIG. 3.

FIG. 5 is a perspective view of a fan-out, similar to the fan-out of FIG. 3, in the first configuration supporting sub-units according to an exemplary embodiment.

FIG. 6 is a perspective view of the fan-out of FIG. 3 in a second configuration.

FIG. 7 is a perspective view of the fan-out of FIG. 5 in the second configuration.

FIG. 8 is a perspective view of the fan-out of FIG. 5 connected to a transition tube according to an exemplary embodiment.

FIG. 9 is a perspective view of a fan-out according to another exemplary embodiment.

FIG. 10 is a perspective view of a fan-out according to yet another exemplary embodiment.

FIG. 11 is a perspective view of a guide according to another exemplary embodiment.

FIG. 12 is a front view of the guide of FIG. 11.

FIG. 13 is a perspective view of a guide, similar to the guide of FIG. 11, according to an exemplary embodiment.

FIG. 14 is a perspective view of the guide of FIG. 11 supporting sub-units according to an exemplary embodiment.

FIG. 15 is a perspective view of the guide of FIG. 13 coupled to a transition tube during a step of manufacturing of the associated furcation system according to an exemplary embodiment.

FIG. 16 is a perspective view of the guide of FIG. 13 coupled to a transition tube during another step of manufacturing of the associated furcation system according to an exemplary embodiment.

### DETAILED DESCRIPTION

Before turning to the Figures, which illustrate exemplary embodiments in detail, it should be understood that the present invention is not limited to the details or methodology set forth in the Detailed Description or illustrated in the Figures. For example, as will be understood by those of ordinary skill in the art, features and attributes associated with embodiments shown in one of the Figures may be applied to embodiments shown in others of the Figures.

Transition to small-diameter trunk cables with round fan-out legs may greatly reduce cable bulk in high-density hardware solutions. Historically, rectangular fan-out tubing was used on multi-fiber connector packages and was difficult to route in the hardware and created preferential bends. These bends may be difficult to manage when using high-density hardware solutions and may make moves, adds, and changes time-consuming. Embodiments of the present invention were at least in part developed to aid in furcating multi-fiber cable assemblies when using round fan-out tubing and round multi-fiber hardware packages, obviating such problems; although the embodiments disclosed herein are not necessarily limited to round or cylindrical configurations.

One of the main failure modes found in conventional cable assembly manufacturing is inverted or crossed fibers. To overcome such failure modes, some current furcation manufacturing methods benefit from managing optical fiber orientation in a flat plane. But, with round fan-out cable specifications and requirements, use of current flat-fiber orientation methods may not work successfully and may lead to increased inverted fiber failures. Embodiments of the present invention, disclosed herein and further discussed below, may successfully manage and orient fibers in a flat plane and then allow the operator to roll or otherwise reorient the fibers in a radial orientation. The radial orientation, particularly when using bend-insensitive fiber, may then be small enough to fit reduced-diameter fan-out leg specifications for improved high-density hardware solutions.

Accordingly, embodiments of the present invention disclosed herein offer advantages for both manufacturing and the consumers, where manufacturing now has a tool to aid in fiber management, the consumers may receive small furcation packages with round fan-out legs that are easy to route and manage in high-density solutions. Effectively managing a 250 μm to 2.9 mm fan-out (or any size), including 900- or 250-micron fiber in some embodiments, through the manufacturing process, helps reduce scrap, inventory, and re-work costs.

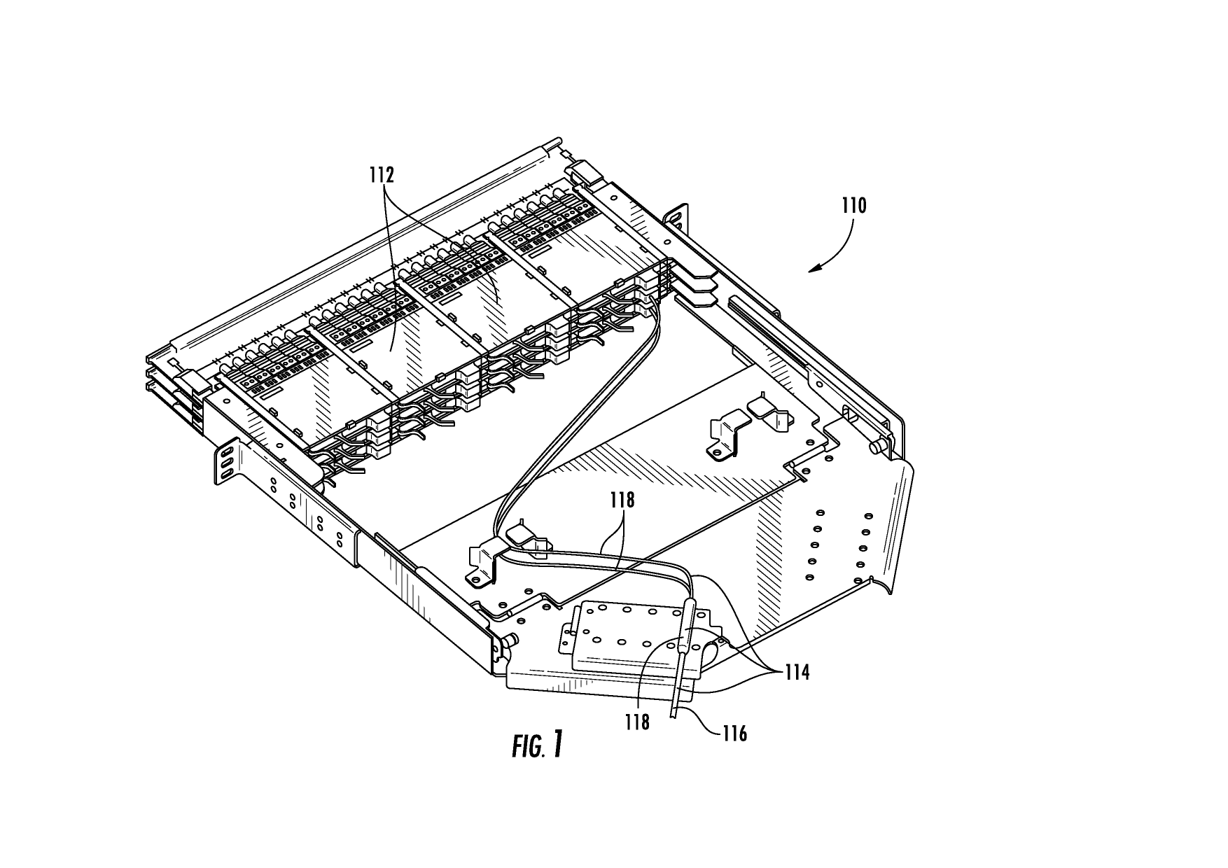

Referring now to FIG. 1, a rack 110 of hardware is configured to provide computerized data communication using optical fibers. The rack 110 includes servers 112, such as horizontal blade servers. The servers 112 may be coupled to computers and other hardware via optical fibers configured to transmit the data. The optical fibers may be arranged in an assembly 114 designed to efficiently conserve space and provide organization in a data center or elsewhere by mainly routing the optical fibers through a truck cable 116 and then furcating the optical fibers, via a furcation system 118, into legs where necessary to access individual or subsets of the fibers.

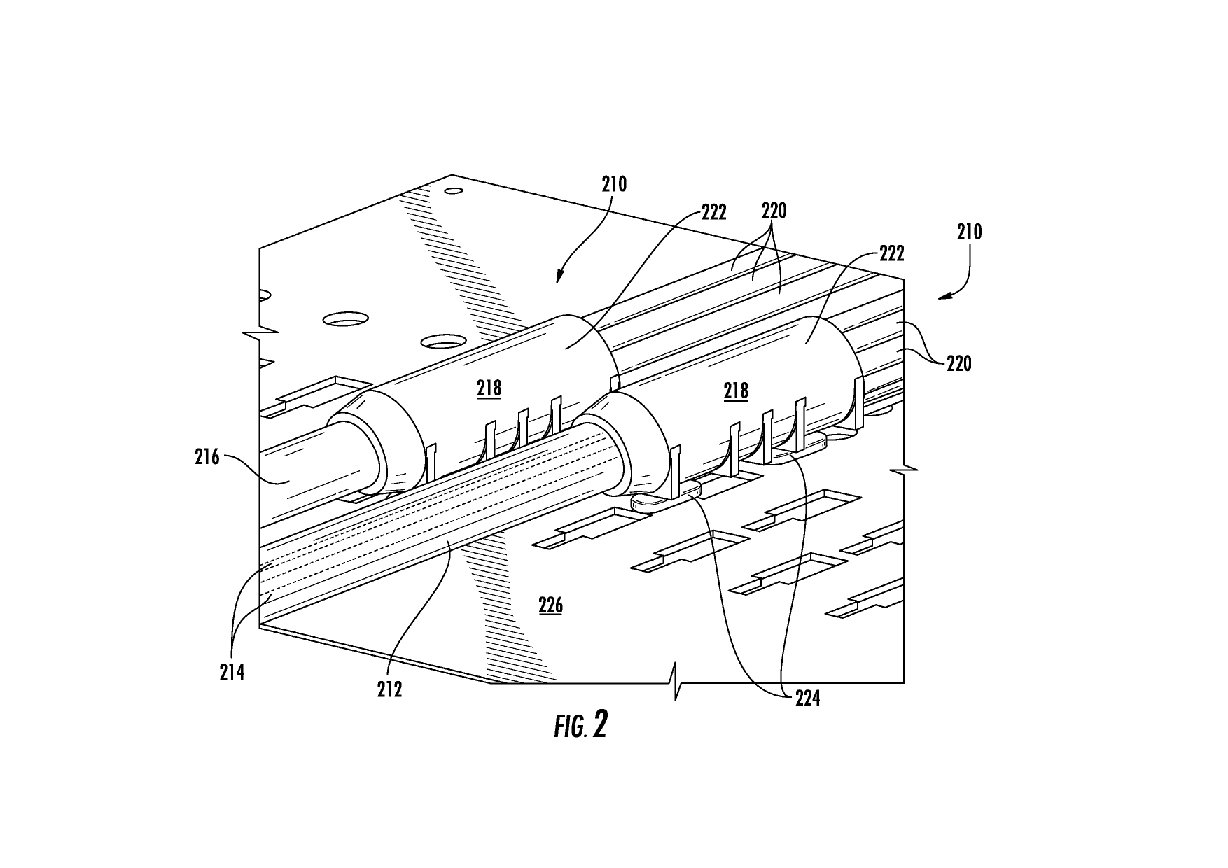

Referring to FIG. 2, an optical fiber assembly 210 includes an optical fiber cable 212 that includes sub-units 214 interior to a jacket 216 of the cable 212. The sub-units 214 may be furcated (i.e., separated) from one another and the jacket via a furcation system 218 to form legs 220 of the assembly 210. Optical fibers of the cable 212 enter one side of the furcation system 218 and the same optical fibers extend to and through the legs 220 of the assembly 210, exiting the other side of the furcation system 218, such as within protective furcation tubes or sleeves. The legs 220 may include or consist of one or more optical fibers for communication with associated computerized machines.

According to an exemplary embodiment, the furcation system 218 includes an exterior shell 222 and an attachment mechanism 224 to connect the furcation system 218 to a tray 226 or other structure. The shell 222 may protect interior components of the furcation system 218, including the sub-units 212 of the optical fiber cable 212, a transition tube, and a fan-out (discussed below). The shell 222 may be cylindrical, rectangular, or otherwise shaped. The attachment mechanism 224 may include one or more clips, pins, welds, adhesives, latches, or other mechanisms.

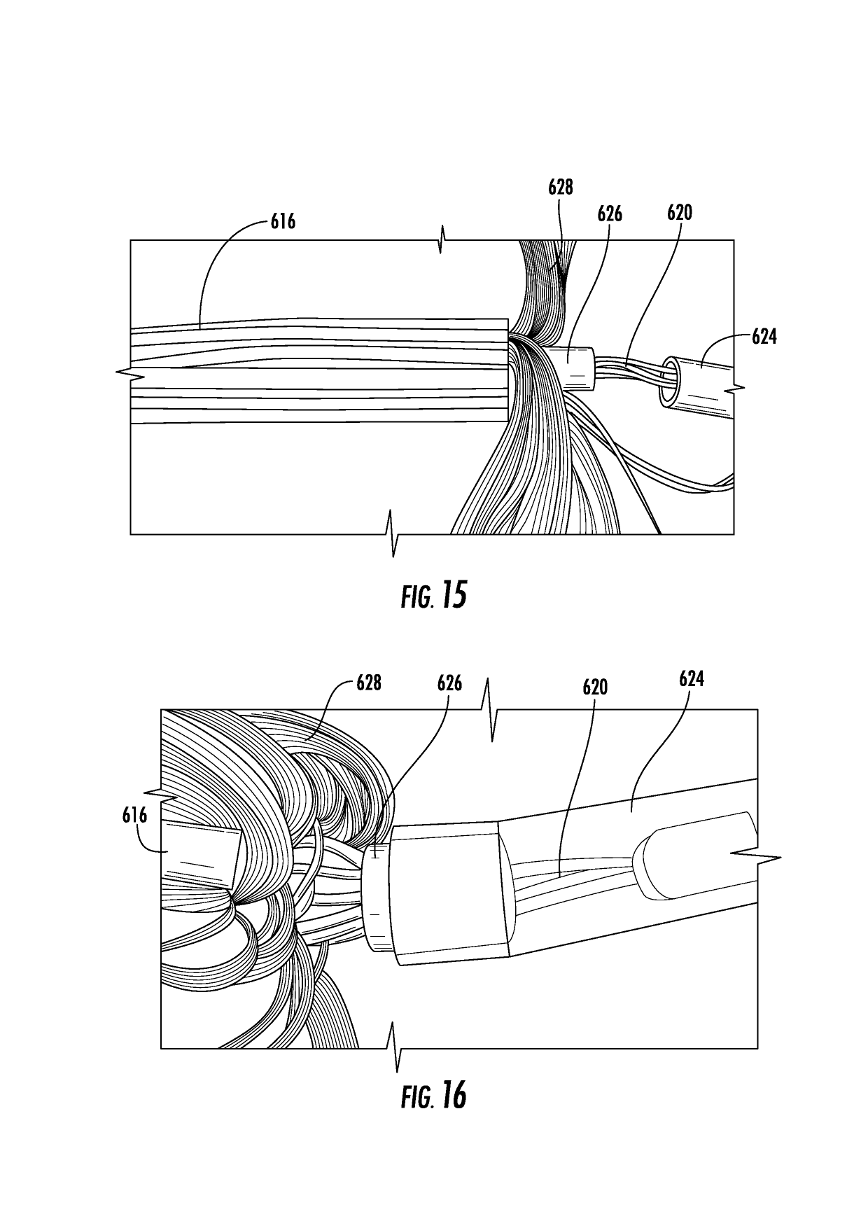

According to an exemplary embodiment, the sub-units 214 of the optical fiber cable include or consist of at least one optical fiber, such as a glass fiber including a core within cladding configured to facilitate optical transmission of data (e.g., bend-insensitive fiber, CLEARCURVE fiber produced by CORNING INCORPORATED). In some embodiments, the sub-units 214 may include a jacket, optical fiber(s), and strength members, such as aramid yarn (see, e.g., yarn 628 as shown in FIGS. 15-16). In other embodiments, the sub-units include buffer tubes with optical fibers, but not strength member. In some embodiments, the sub-units include tight-buffered optical fibers. In still other embodiments, the sub-units may consist of optical fibers, such as individual optical fibers, groups of loose optical fibers, ribbons of optical fibers, stacks of ribbons, etc.

Referring to FIGS. 3-5, a fan-out 310 (e.g., separating element, parsing device, guide) includes a surface 312 (e.g., strip of material, substrate, base) and stations 314 (e.g., ports, guides) configured to receive and hold sub-units 316 of an optical fiber cable, while allowing the sub-units 316 to project from the stations 314, such as into legs of a cable assembly. The stations 314 are coupled to at least one side 318 of the surface 312 (e.g., top face), and in some embodiments are coupled to only the one side 318. According to an exemplary embodiment, the surface 312 is flexible such that the surface 312 is configured to be changed from flat to curved (e.g., the surface 312 folds, bends, rolls, curves, etc.).

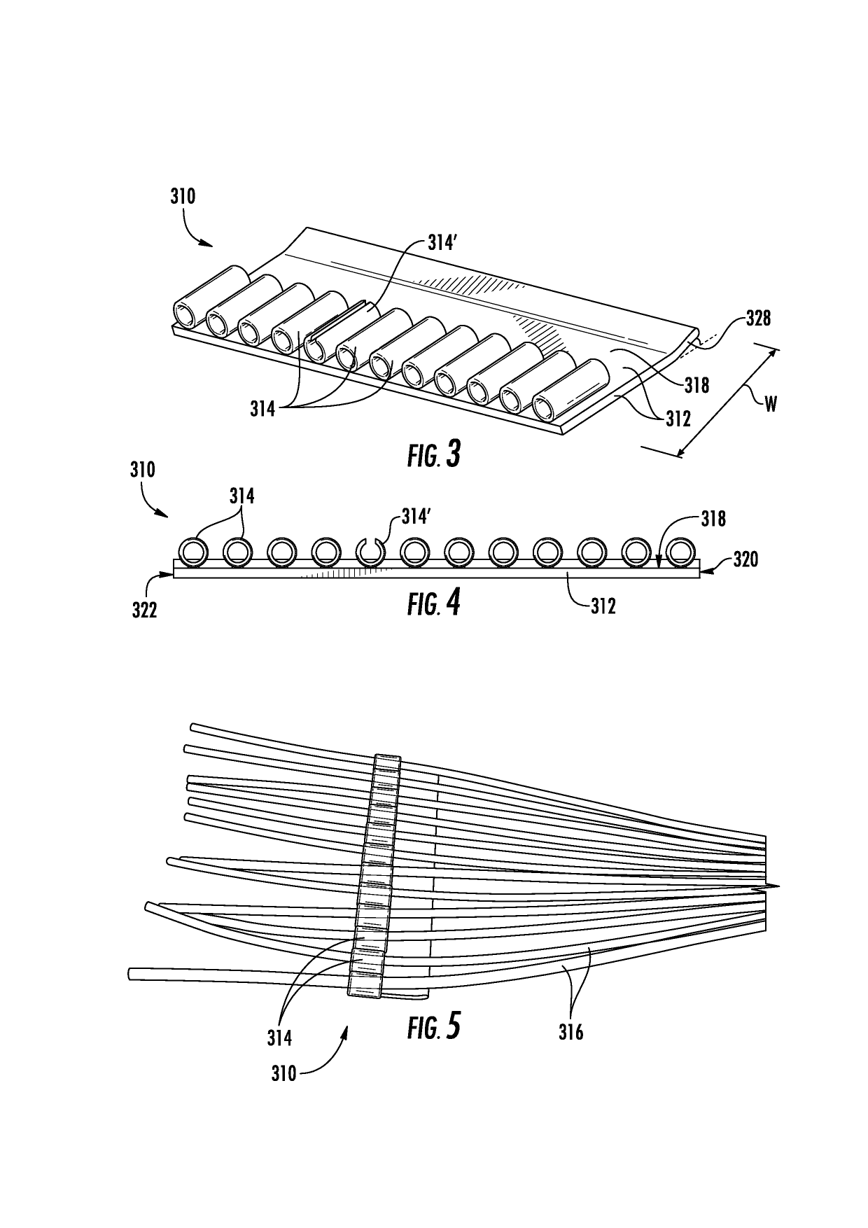

According to an exemplary embodiment, the stations 314 are spaced apart from one another such that the stations 314 provide separation between the sub-units 316 received by the stations 314. The stations 314 may be uniformly positioned along the surface 312 between opposing ends 320, 322 (FIG. 4) of the surface 312, or may be otherwise positioned. The stations 314 may be parallel to one another. The stations 314 may extend less than the full width W (FIG. 3) of the one side 318 of the surface, such as less than half the full width W.

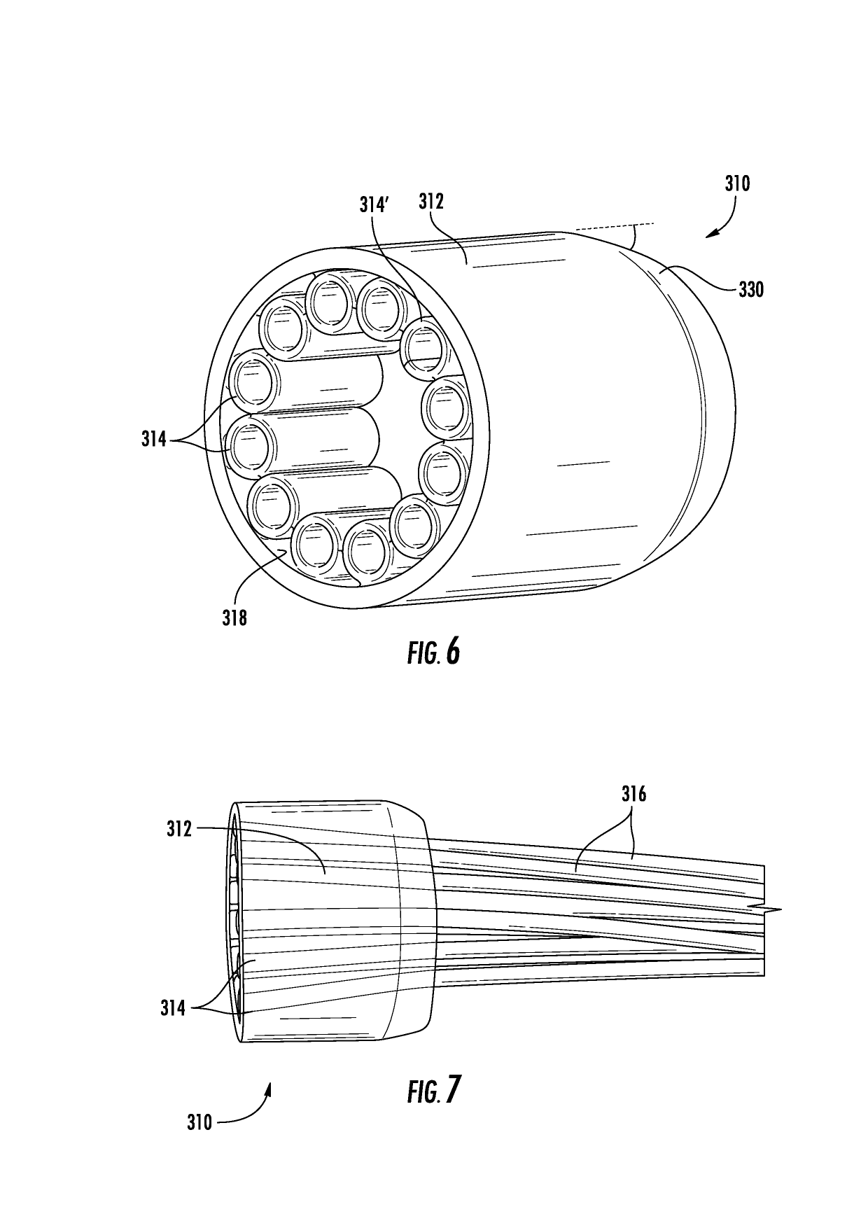

According to an exemplary embodiment, the surface has a raised edge 328 as shown in FIG. 3 such that, in a cylindrical configuration as shown in FIG. 6, the raised edge 328 forms a beveled end 330 to the cylinder. In some embodiments, the stations 314 are positioned along an edge of the surface 312 that is away from the raised edge 328, as shown in FIG. 3. The stations 314 may not extend fully to or overlap the raised edge 328 in some embodiments.

According to an exemplary embodiment, the stations 314 of the fan-out 310 are configured to hold the sub-units 316 of the optical fiber cable, while allowing the sub-units 316 to project form the stations 314. In some embodiments, the stations 314 are conduits (e.g., cylinders, tunnels, etc.). Some or all of the stations 314 of a particular fan-out 310 may be the conduits, while in other embodiments other arrangements or structures may be used to hold the sub-units 316 to the flexible surface 312 of the fan-out 310.

In some embodiments, some or all of the stations 314′ may be C-shaped (e.g., clips) in cross-section such that the C-shape is greater than 180-degrees and less than a closed loop, but otherwise similar to the conduit stations 314. The opening to the C-shaped station 314′ may be opposite to the surface 312. During assembly, the sub-units 316 may be pushed into the opening of the C-shaped stations 314′ and held in place via the interior surfaces of the free ends of the C-shape (i.e., the portions of the C-shape greater than 180-degrees and furthest from the surface 312). Folding the surface 312 during assembly may further close the C-shape by causing exterior surfaces of adjacent stations 314′ to contact and compress one another, improving the coupling between the station 314′ and the respective sub-unit 316.

According to an exemplary embodiment, the fan-out 310 may be formed from plastic or polymer, and may be integrally-formed with the surface 312 and stations 314 formed from a single, continuous material via molding or other manufacturing methods. In other embodiments, the fan-out may be formed form different materials or a combination of materials, such as a thin, flexible metal sheet for the surface 312 with polymeric conduits fastened to the sheet to form the stations 314.

The sub-units 316 may be inserted into the stations 314 when the surface 312 is laying flat, such as on a tabletop, which may allow for quick and accurate manufacturing. Referring now to FIGS. 6-8, once the sub-units 316 are properly positioned in the respective stations 314, bending of the surface 312 moves the stations 314 from a planar arrangement (FIGS. 3-4) to a three-dimensional arrangement (e.g., FIGS. 6-8) such that the sub-units 316 project from the stations 314 of the fan-out in three-dimensional arrays. In contemplated embodiments, the fan-out may be rolled without or prior to receiving the sub-units 316.

When configured for insertion into the furcation system, the fan-out 310 may be cylindrical, as shown in FIGS. 6-8, with a smooth and round exterior. In other contemplated embodiments, the stations are connected together by webbing along mid-sides of the stations to form the surface, such that the fan-out includes a portion of the stations forming bumps on the interior and exterior of the cylinder. In other embodiments, contact between the stations, when the fan-out is formed in a cylinder, provides tension in the surface such that the surface has flat portions between bends in the exterior periphery of the surface. Put another way, the exterior of such a cylinder is somewhat polygonal, where the number of sides of the polygon correspond to the number of stations within the cylinder, and the vertices of the polygon are rounded. In some embodiments, the surface may flex via joints or hinges. In contemplated embodiments, the fan-out may be arranged to have an overall cross-section other than a circle, such as a square or rectangular cross-section for a box-shaped furcation system, triangular, or an otherwise-shaped cross section. Spacing of the stations may correspond to forming of the fan-out to a particular three-dimensional geometry because contact between the stations in the interior of the curved surface when the surface is rolled may facilitate the shape that the rolled-surface forms.

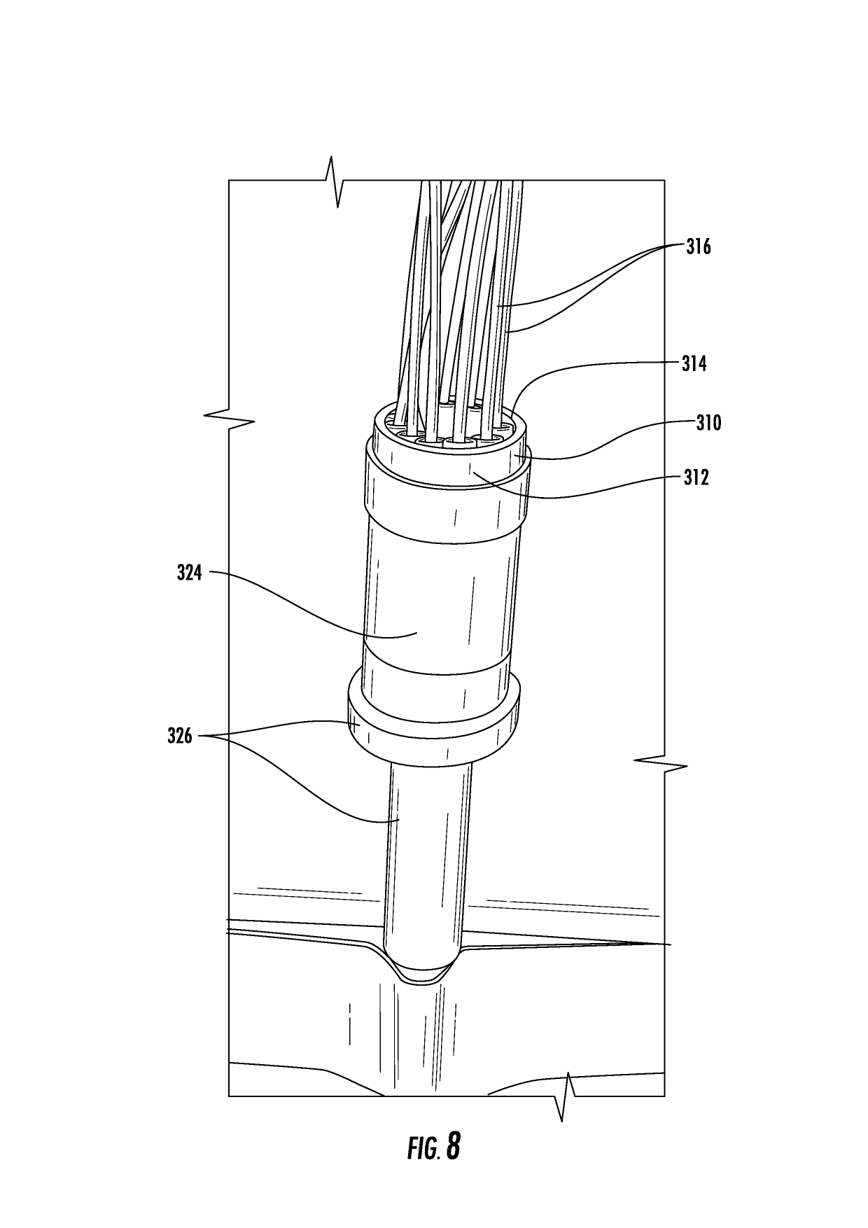

As shown in FIG. 8, once formed in a desired three-dimensional configuration, epoxy 324 or other adhesive may be inserted into an interior of the fan-out cylinder to hold the sub-units 316 in place and fix the cylinder shape of the fan-out 310. The epoxy 324 may be additionally used to hold a transition tube 326 to the fan-out 310, where the transition tube 326 receives the sub-units 316 from the optical fiber cable and provides the sub-units 316 to the fan-out 310. In some embodiments, the transition tube 326 and fan-out 310 may be housed in the shell of the furcation system, as shown in FIG. 2.

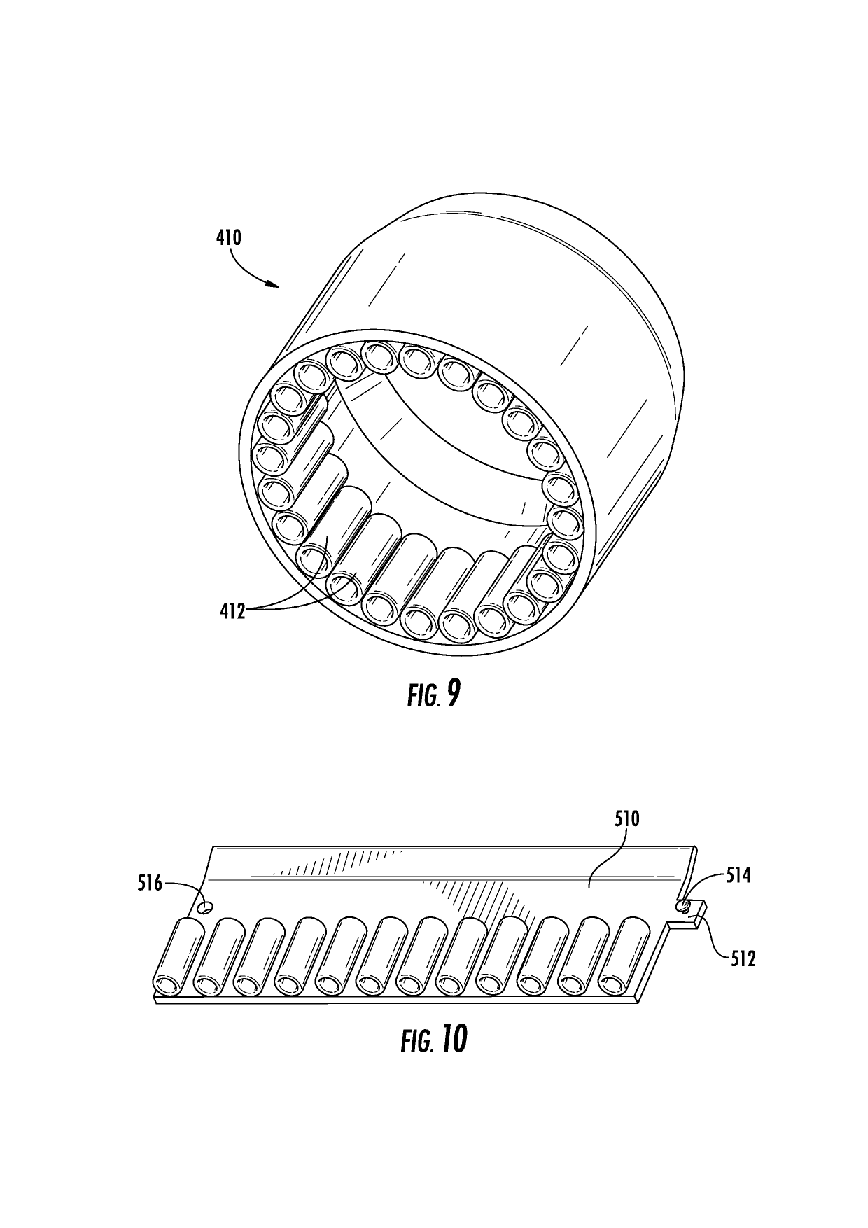

Referring now to FIG. 9, a fan-out 410, similar to the fan-out 310, includes a greater number of stations 412. Fan-outs according to exemplary embodiments, may include more than one station, such as at least twelve stations.

Referring to FIG. 10, a fan-out 510, similar to fan-out 310, includes an integrated fastener 512, including male and female connectors 514, 516. Once the fan-out 510 is formed as a cylinder, the male connector 514 may be inserted into the female connector 516 to hold the cylindrical shape. Integrating the fastener 512 into a continuous, single-body, integral fan-out 510 may save manufacturing steps of gathering a fastener, and may also save costs and materials associated with other types of fasteners. Furthermore, the integrated fastener 512 cannot be separated from the fan-out 510, therefore obviating risks of losing or dropping the fastener 512. In other embodiments, tape, glue, welds, different types of mechanical fasteners (e.g., clips, pins, staples, etc.), and other types of fasteners may be used.

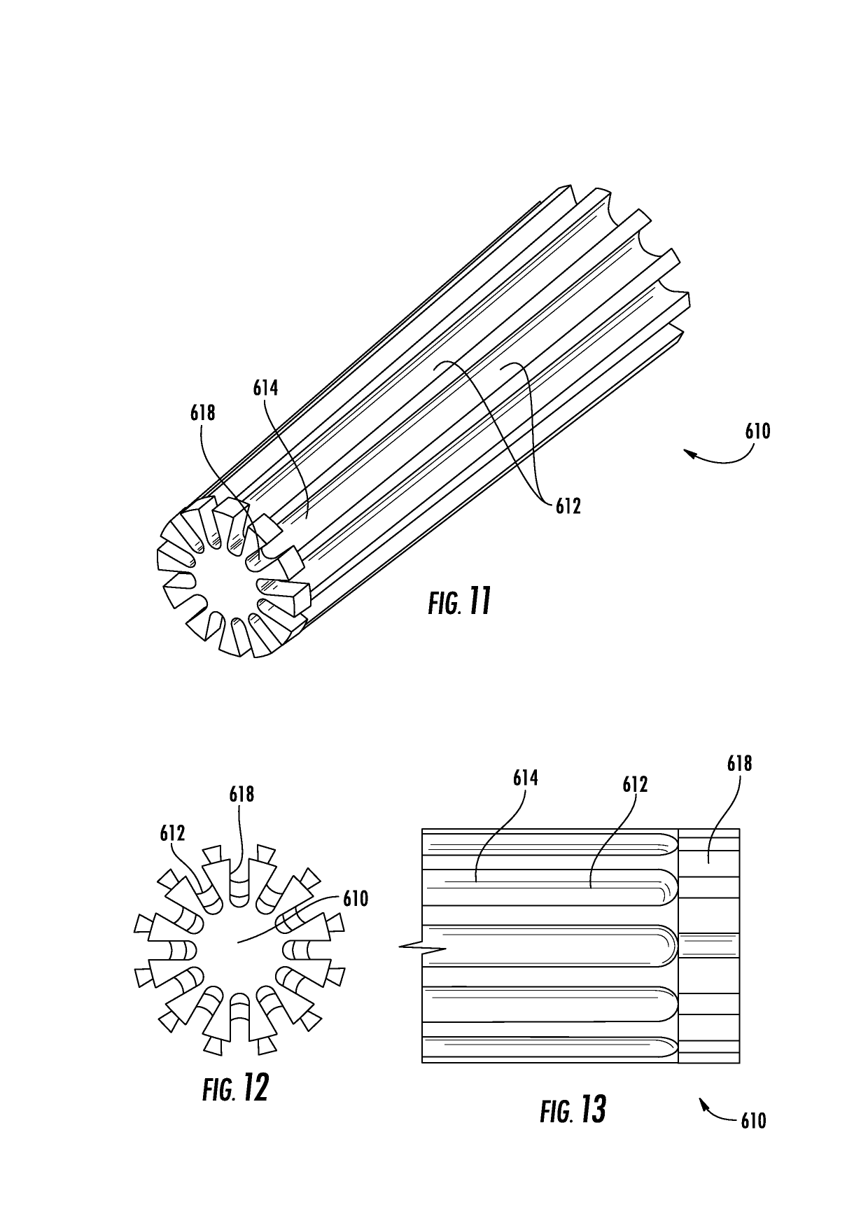

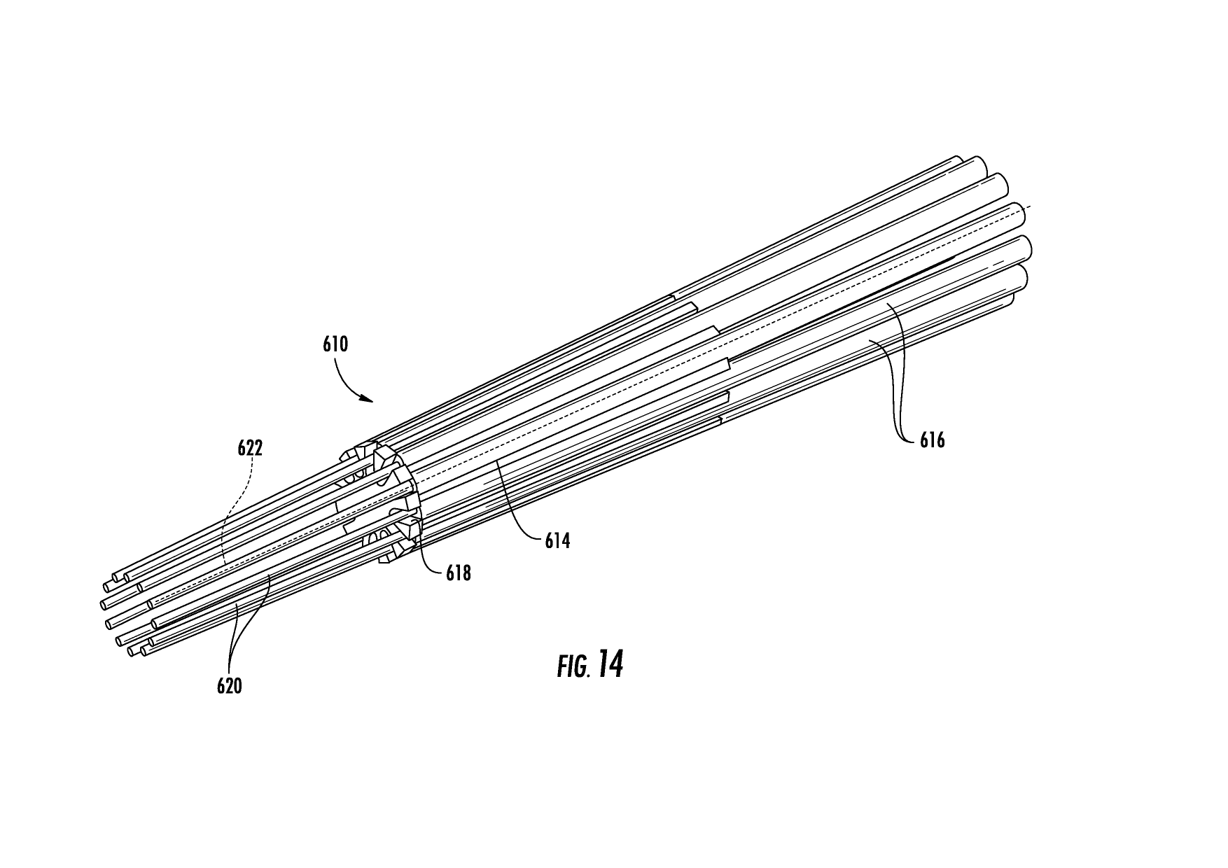

Referring now to FIGS. 11-14, a guide 610 for a furcation system includes tracks 612 extending longitudinally along the exterior of the guide 610. The tracks 612 may be U- or C-shaped, similar to the stations 314′ (see FIG. 4). According to an exemplary embodiment, each of the tracks 612 includes a wider section 614 configured to receive a conduit 616 (FIG. 14; e.g., furcation sleeve, tube), and a narrower portion 618, through which a sub-unit extends, such as a sub-unit 620 including or consisting of one or more optical fibers 622.

During assembly of the furcation system, separate conduits 616 may be drawn over the sub-units 620 that extend through the narrower portion of the guide 610. According to an exemplary embodiment, the guide 610 provides organized support and separation of the portions sub-units 620 and the conduits 616, and further provides structural support (e.g., crush resistance, impact protection) to an area in the furcation system where the optical fibers 622 may otherwise be exposed during assembly of the furcation system, such as between the fan-out 310 and the guide 610, if both are used.

Referring to FIGS. 5, 7-8, and 15-16, during assembly of a furcation system, a jacket may be separated or drawn back from an optical fiber cable, exposing sub-units 622 of the cable. The sub-units 622 may then be directed to a fan-out by way of a transition tube 626 to be coupled to the optical fiber cable (see, e.g., fan-out 310 as shown in FIG. 3 and transition tube 326 as shown in FIG. 8). The sub-units 622 may be furcated via stations of the fan-out, while the fan-out is laying flat (see generally FIG. 5). The fan-out may then be curved to and locked in a cylindrical configuration with the sub-units 622 extending in a radial manner from the end of the fan-out (see generally FIG. 7).

According to an exemplary embodiment, conduits 616 (e.g., furcation sleeves) may then be slid over the sub-units 620 to provide structure for handling of the sub-units 620. The conduits 616 may be integrated with or held by the stations of the fan-out. In some embodiments, the conduits 616 may be aligned and supported by the guide 610. In other embodiments, the guide 610 may be used in place of the fan-out, or may not be used at all with the fan-out. A fan-out kit, including any combination of some or all of the various components described herein (e.g., sub-units 620, fan-out 310, transition tube 626, guide 610), may be enclosed by a sleeve 624 or wrap, and epoxy may be used to encase the components. The fan-out kit may then be enclosed in a shell and attached to a rack, as shown in FIGS. 1-2.

Due to the unique structural features (e.g., flat to curved configurations) and method steps disclosed herein, embodiments of the present invention allow a manufacturer of furcation systems to effectively manage polarity, reduce crossed fibers, and prevent inverted fiber failures within manufacturing. Embodiments disclosed herein allow the operator to build an optical fiber cable assembly with the fibers in a flat, straight orientation. Once the fibers are loaded in the correct scheme, the operator may then roll the assembly into a round package that conveniently matches the diameter of the specific fan-out or transition tubing used for that particular assembly. The ability to manage fibers in a flat orientation and then transition that into a round package offers numerous advantages for both manufacturing and consumer. More specifically, advantages provided by embodiments of the invention disclosed herein include: managing polarity when using round fan-out legs on high-fiber-count cable assemblies; reducing inverted or crossed fiber failures within the transition tube during manufacturing; reducing furcation sizes and related costs or the need for bulky molded plugs and expensive epoxy; preventing crossing fibers within the furcation and the insertion losses related to crossed fiber; providing a scalable system to four-fiber, six-fiber, and eight-fiber or higher fiber-count optical fiber assemblies; accommodating 900 micron, 1.6 mm, 2.0 mm, 2.9 mm, and other size tubing requirements; and providing faster ease of assembly, requiring less epoxy.

Embodiments of the present invention disclosed herein allow cable assembly manufacturers to continue to pursue smaller-diameter fan-out assembly designs as data centers continue pursuing increasingly high-density hardware requirements. Embodiments disclosed herein allow the cable assembly manufacturer to reduce the failures related to inverted fibers as well as allow for reduced and simplified furcation processes, continued use of small-diameter round fan-out tubes, and reduced costs of the overall furcation process. The cost reduction is perceived to be both a labor and material reduction. Reducing the amount of reworks due to polarity failures, increases on-time deliveries because polarity failures may not be recognized until a final test station, at which point the connector must otherwise be cut off of the assembly and transported back to the connectorization work cell.

The construction and arrangements of the fan-outs and furcation systems and methods, as shown in the various exemplary embodiments, are illustrative only. Although only a few embodiments have been described in detail in this disclosure, many modifications are possible (e.g., variations in sizes, dimensions, structures, shapes, and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present invention.

What is claimed is:

1. A furcation system of an optical fiber cable assembly, comprising:
a fan-out, comprising:
a surface that is flexible such that the surface is configured to be changed from flat to curved; and
stations coupled to one side of the surface, wherein the stations are configured to receive and hold sub-units of an optical fiber cable, while allowing the sub-units to project from the stations;
wherein the stations are spaced apart from one another such that the stations provide separation between the sub-units received by the stations, and wherein bending of the surface moves the stations from a planar arrangement to a three-dimensional arrangement such that the sub-units may project from the stations of the fan-out in planar or three-dimensional arrays; and
a transition tube configured to be attached to the fan-out and the optical fiber cable, wherein the transition tube receives the sub-units from the optical fiber cable and provides the sub-units to the fan-out.

2. The furcation system of claim 1, wherein the surface of the fan-out is configured to be changed from flat to cylindrical such that the three-dimensional arrangement corresponds to a round projection of the sub-units from the fan-out.

3. The furcation system of claim 2, wherein the stations are uniformly positioned between lateral ends of the surface when the surface is flat.

4. The furcation system of claim 3, wherein the fan-out is configured such that the lateral ends of the surface are connected to one another and the surface is in a cylindrical configuration with the stations interior to the cylinder.

5. The furcation system of claim 4, wherein the fan-out further comprises adhesive used to hold the surface of the fan-out in the cylindrical configuration.

6. The furcation system of claim 5, wherein the adhesive additionally holds the transition tube to the fan-out.

7. The furcation system of claim 4, wherein the surface of the fan-out has a raised edge such that, in the cylindrical configuration, the raised edge forms a beveled end to the cylinder.

8. The furcation system of claim 1, wherein the stations include conduits, and wherein the conduits are cylindrical and have open ends such that one of the sub-units may be inserted in one of the open ends and the sub-unit may project from the other of the open ends.

9. The furcation system of claim 8, wherein exterior surfaces of the conduits are configured to contact one another when the fan-out is in a cylindrical configuration such that the conduits provide rigidity to the fan-out to limit further flexing of the fan-out beyond the cylindrical configuration.

10. A fan-out for a furcation system of an optical fiber assembly, comprising:
a surface that is flexible, wherein the surface, in a flat configuration, is elongate and has opposite lateral ends; and
stations for receiving sub-units of an optical fiber cable, wherein the stations are coupled to one side of the surface, between the opposite lateral ends of the surface;
wherein the stations are spaced apart from one another such that the stations provide separation between the sub-units received by the stations; and
wherein the surface is flexible such that the opposite lateral ends of the surface are configured to be connected to one another, forming the fan-out in a cylindrical configuration with the stations on the interior of the cylinder.

11. The fan-out of claim 10, wherein the stations include conduits, and wherein the conduits are cylindrical and have open ends such that one of the sub-units may be inserted in one of the open ends and the sub-unit may pass through the respective conduit and project from the other of the open ends.

12. The fan-out of claim 11, wherein exterior surfaces of the conduits are configured to contact one another when the fan-out is in the cylindrical configuration such that the conduits provide rigidity to the fan-out to limit further flexing of the fan-out beyond the cylindrical configuration.

13. The fan-out of claim 10, wherein the surface has a raised edge such that, in the cylindrical configuration, the raised edge forms a beveled end to the cylinder.

14. The fan-out of claim 13, wherein the stations are positioned along an edge of the surface away from the raised edge.

15. The fan-out of claim 10, further comprising adhesive used to hold the surface in the cylindrical configuration.

16. The fan-out of claim 15, wherein the adhesive is epoxy filling at least a portion of the interior of the cylinder between and around the exterior of the stations.

17. A method of using a furcation system, comprising steps of:
inserting sub-units of an optical fiber cable into first ends of conduits positioned along a surface of a fan-out such that the sub-units extend through the conduits and project from second ends of the conduits, wherein the surface is flexible; and
bending the surface to connect lateral ends of the surface to one another in order to form a cylinder with the conduits interior to the cylinder.

18. The method of claim 17, further comprising a step of fastening together the lateral ends of the surface connected to form the cylinder.

19. The method of claim 18, further comprising steps of:
attaching the cylinder to a transition tube; and
providing epoxy to the interior of the cylinder such that the epoxy fills at least a portion of the interior of the cylinder between and around the exterior of the conduits.

20. The method of claim 17, further comprising a step of removing an end portion of a jacket of the optical fiber cable to expose the sub-units.
